(19) United States
(12) Patent Application Publication
(10) Pub. No.: US 2014/0375256 A1
(43) Pub. Date: Dec. 25, 2014

(54) WIRELESS POWER TRANSMISSION SYSTEM WITH ABILITY TO DETERMINE CHARGING CIRCUMSTANCES

(71) Applicant: SAMSUNG ELECTRONICS CO., LTD., Suwon-si (KR)

(72) Inventors: Byoung Hee LEE, Yongin-si (KR); Sang Wook KWON, Seongnam-si (KR); Ki Young KIM, Yongin-si (KR); Dong Zo KIM, Yongin-si (KR); Bong Chul KIM, Seoul (KR); Yun Kwon PARK, Dongducheon-si (KR); Jae Hyun PARK, Yongin-si (KR); Keum Su SONG, Seoul (KR); Chi Hyung AHN, Suwon-si (KR); Young Ho RYU, Yongin-si (KR)

(73) Assignee: SAMSUNG ELECTRONICS CO., LTD., Suwon-si (KR)

(21) Appl. No.: 14/146,026

(22) Filed: Jan. 2, 2014

(30) Foreign Application Priority Data
Jun. 20, 2013 (KR) 10-2013-0070831

(51) Int. Cl. H01F 38/14; H02J 7/02

(52) U.S. Cl. CPC H01F 38/14; H02J 7/025
USPC 320/108; 307/104; 320/137

(57) ABSTRACT

A wireless power receiver includes a power receiver configured to wirelessly receive power, and including a direct current (DC)-to-DC (DC/DC) converter, and a power detector configured to detect power detection information from a front end of the DC/DC converter.

### CROSS-REFERENCE TO RELATED APPLICATION

This application claims the benefit under 35 USC 119(a) of Korean Patent Application No. 10-2013-0070831, filed on Jun. 20, 2013, in the Korean Intellectual Property Office, the entire disclosure of which is incorporated herein by reference for all purposes.

### BACKGROUND

1. Field

The following description relates to a wireless power transmission system.

2. Description of Related Art

Wireless power refers to energy that is transferred from a wireless power transmission apparatus to a wireless power reception apparatus through magnetic coupling. Accordingly, a wireless power charging system includes a source device configured to wirelessly transmit power, and a target device configured to wirelessly receive power. The source device may be referred to as a wireless power transmission apparatus, and the target device may be referred to as a wireless power reception apparatus.

The source device may include a source resonator, and the target device may include a target resonator. Magnetic coupling or resonant coupling may be formed between the source resonator and the target resonator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a wireless power receiver includes a power receiver configured to wirelessly receive power, and including a direct current (DC)-to-DC (DC/DC) converter, and a power detector configured to detect power detection information from a front end of the DC/DC converter.

The power may be used to charge a load.

The wireless power receiver may further include a communication controller configured to transmit the power detection information to a wireless power transmitter.

The power detector may be configured to detect the power detection information, while maintaining a frequency band in which the power is wirelessly received.

The power detector may be configured to detect the power detection information, while the power receiver wirelessly receives the power.

The power receiver may further include a rectifier, and the power detector may be configured to detect the power detection information between the DC/DC converter and the rectifier.

The wireless power receiver may further include a communication controller configured to determine a charging circumstance of a load based on the power detection information, determine whether the charging circumstance satisfies a predetermined condition, and transmit a charging stop signal to a wireless power transmitter in response to the charging circumstance being determined to not satisfy the predetermined condition.

The power detection information may include current, or voltage, or power, or any combination thereof at the front end of the DC/DC converter.

In another general aspect, a wireless power transmitter includes a communication controller configured to receive, from a wireless power receiver, power detection information detected from a front end of a direct current (DC)-to-DC (DC/DC) converter of the wireless power receiver, and a power transmitter configured to wirelessly transmit power based on the power detection information.

The communication controller may be further configured to determine a charging circumstance of a load based on the power detection information, and determine whether the charging circumstance satisfies a predetermined condition.

The power transmitter may be configured to wirelessly transmit the power to the wireless power receiver in response to the charging circumstance being determined to satisfy the predetermined condition.

The communication controller may be configured to determine whether the charging circumstance satisfies the predetermined condition, while maintaining a frequency band in which the power is wirelessly transmitted.

The power transmitter may be configured to continue to wirelessly transmit the power to the wireless power receiver, while the communication controller determines whether the charging circumstance satisfies the predetermined condition.

The communication controller may be configured to determine whether the load is recognized, and determine whether the charging circumstance satisfies the predetermined condition in response to the load being recognized.

In still another general aspect, a wireless power reception method includes wirelessly receiving power, using a power receiver including a direct current (DC)-to-DC (DC/DC) converter, and detecting power detection information from a front end of the DC/DC converter.

The wireless power reception method may further include transmitting the power detection information to a wireless power transmitter.

The wireless power reception method may further include determining a charging circumstance of a load based on the power detection information, determining whether the charging circumstance satisfies a predetermined condition, and transmitting a charging stop signal to a wireless power transmitter in response to the charging circumstance being determined to not satisfy the predetermined condition.

In yet another general aspect, a wireless power transmission method includes receiving, from a wireless power receiver, power detection information detected from a front end of a direct current (DC)-to-DC (DC/DC) converter of the wireless power receiver, and wirelessly transmitting power based on the power detection information.

The wirelessly transmitting may include determining a charging circumstance of a load based on the power detection information, determining whether the charging circumstance satisfies a predetermined condition, and wirelessly transmitting the power to the wireless power receiver in response to the charging circumstance being determined to satisfy the predetermined condition.

The wireless power transmission method may further include stopping the wirelessly transmitting, and providing a user with a warning that indicates the stopping, in response to the charging circumstance being determined to not satisfy the predetermined condition.

In still another general aspect, a wireless power receiver includes a resonator configured to wirelessly receive power from a wireless power transmitter, a direct current (DC)-to-DC (DC/DC) converter connected to the resonator, and a power detector configured to detect current, or voltage, or power, or any combination thereof at a front end of the DC/DC converter.

The wireless power receiver may further include a communication controller configured to transmit, to the wireless power transmitter, the detected current, or voltage, or power, or any combination thereof.

The wireless power receiver may further include a rectifier configured to rectify the power to a DC voltage. The DC/DC converter may be configured to adjust the DC voltage, and the power detector may be configured to detect the current, or voltage, or power, or any combination thereof between the rectifier and the DC/DC converter.

The wireless power receiver may be an electric vehicle, or a smart device, or a laptop, or a camera, or any combination thereof.

Other features and aspects will be apparent from the following detailed description, the drawings, and the claims.

### BRIEF DESCRIPTION OF THE DRAWINGS

FIG. 1 is a diagram illustrating an example of a wireless power transmission system.

FIGS. 2A through 2B are diagrams illustrating examples of a distribution of a magnetic field in a feeder and a resonator of a wireless power resonator.

FIGS. 3A and 3B are diagrams illustrating an example of a feeding unit and a resonator of a wireless power transmitter.

FIG. 4A is a diagram illustrating an example of a distribution of a magnetic field in a resonator that is produced by feeding of a feeding unit, of a wireless power transmitter.

FIG. 4B is a diagram illustrating examples of equivalent circuits of a feeding unit and a resonator of a wireless power transmitter.

FIG. 5 is a diagram illustrating an example of an electric vehicle charging system.

FIGS. 6A through 7B are diagrams illustrating examples of applications in which a wireless power receiver and a wireless power transmitter are mounted.

FIG. 8 is a diagram illustrating another example of a wireless power transmission system.

FIGS. 9A and 9B are diagrams illustrating examples of a pad-type wireless power transmission system.

FIG. 10 is a diagram illustrating an example of a space-type wireless power transmission system.

FIG. 11 is a diagram illustrating still another example of a wireless power transmission system.

FIG. 12 is a block diagram illustrating an example of a wireless power receiver.

FIG. 13 is a flowchart illustrating an example of a wireless power transmission method.

Throughout the drawings and the detailed description, unless otherwise described, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

A scheme of performing communication between a source device and a target device may include an in-band communication scheme, and an out-band communication scheme. The in-band communication scheme means communication performed between the source device and the target device in the same frequency band as used for power transmission. The out-band communication scheme means communication performed between the source device and the target device in a separate frequency band than one used for power transmission.

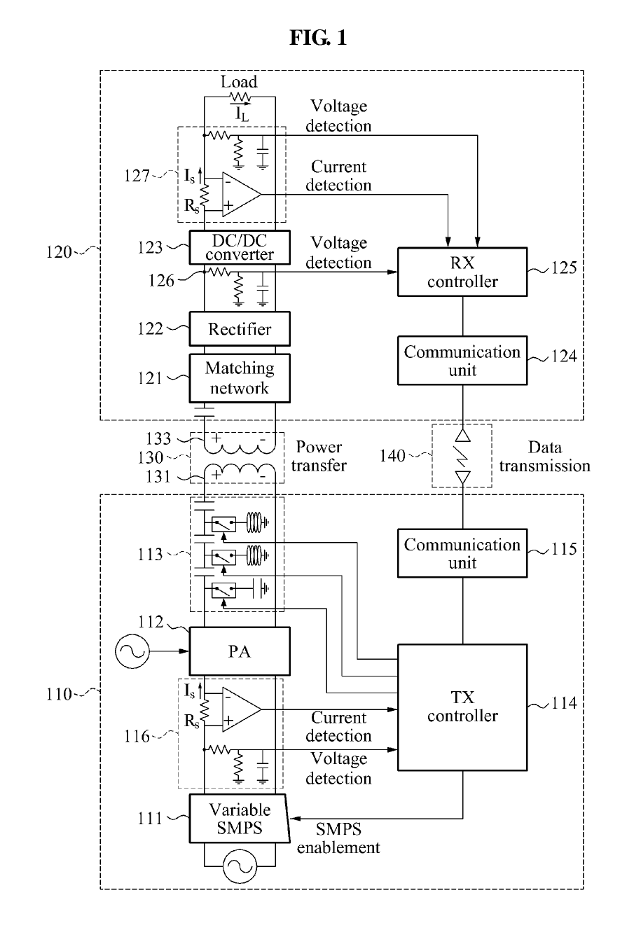

FIG. 1 is a diagram illustrating an example of a wireless power transmission system. Referring to FIG. 1, the wireless power transmission system includes a source device 110 and a target device 120. The source device 110 is a device supplying wireless power, and may be any of various devices that supply power, such as pads, terminals, televisions (TVs), and any other device that supplies power. The target device 120 is a device receiving wireless power, and may be any of various devices that consume power, such as terminals, TVs, vehicles, washing machines, radios, lighting systems, and any other device that consumes power.

The source device 110 includes a variable switching mode power supply (SMPS) 111, a power amplifier 112, a matching network 113, a transmission (TX) controller 114, a communication unit 115, a power detector 116, and a source resonator 131. The target device 120 includes a matching network 121, a rectifier 122, a direct current-to-direct current (DC/DC) converter 123, a communication unit 124, a reception (RX) controller 125, a power detector 127, and a target resonator 133.

The variable SMPS 111 generates a DC voltage by switching an alternating current (AC) voltage having a frequency of tens of hertz (Hz) output from a power supply. The variable SMPS 111 may output a DC voltage having a predetermined level, or may output a DC voltage having an adjustable level by the TX controller 114.

The power detector 116 detects an output current and an output voltage of the variable SMPS 111, and provides, to the TX controller 114, information on the detected current and the detected voltage. Additionally, the power detector 116 detects an input current and an input voltage of the power amplifier 112.

The power amplifier 112 generates a power by converting the DC voltage output from the variable SMPS 111 to an AC voltage using a switching pulse signal having a frequency of a few kilohertz (kHz) to tens of megahertz (MHz). In other words, the power amplifier 112 converts a DC voltage supplied to a power amplifier to an AC voltage using a reference resonance frequency F_{Ref}, and generates a communication power to be used for communication, or a charging power to be used for charging that may be used in a plurality of target devices. The communication power may be, for example, a low power of 0.1 to 1 milliwatts (mW) that may be used by a target device to perform communication, and the charging power may be, for example, a high power of 1 mW to 200 Watts (W) that may be consumed by a device load of a target device. In this description, the term “charging” may refer to supplying power to an element or a unit that charges a battery or other rechargeable device with power. Also, the term “charging” may refer supplying power to an element or a unit that consumes power. For example, the term “charging power” may refer to power consumed by a target device while operating, or power used to charge a battery of the target device. The unit or the element may include, for example, a battery, a display device, a sound output circuit, a main processor, and various types of sensors.

In this description, the term “reference resonance frequency” refers to a resonance frequency that is nominally used by the source device 110, and the term “tracking frequency” refers to a resonance frequency used by the source device 110 that has been adjusted based on a predetermined scheme.

The TX controller 114 may detect a reflected wave of the communication power or a reflected wave of the charging power, and may detect mismatching between the target resonator 133 and the source resonator 131 based on the detected reflected wave. The TX controller 114 may detect the mismatching by detecting an envelope of the reflected wave, or by detecting an amount of a power of the reflected wave.

Under the control of the TX controller 114, the matching network 113 compensates for impedance mismatching between the source resonator 131 and the target resonator 133 so that the source resonator 131 and the target resonator 133 are optimally-matched. The matching network 113 includes combinations of a capacitor and an inductor that are connected to the TX controller 114 through a switch, which is under the control of the TX controller 114.

The TX controller 114 may calculate a voltage standing wave ratio (VSWR) based on a voltage level of the reflected wave and a level of an output voltage of the source resonator 131 or the power amplifier 112. When the VSWR is greater than a predetermined value, the TX controller 114 detects the mismatching. In this example, the TX controller 114 calculates a power transmission efficiency of each of N predetermined tracking frequencies, determines a tracking frequency F_{Best} having the best power transmission efficiency among the N predetermined tracking frequencies, and changes the reference resonance frequency F_{Ref} to the tracking frequency F_{Best}.

Also, the TX controller 114 may control a frequency of the switching pulse signal used by the power amplifier 112. By controlling the switching pulse signal used by the power amplifier 112, the TX controller 114 may generate a modulation signal to be transmitted to the target device 120. In other words, the communication unit 115 may transmit various messages to the target device 120 via in-band communication. Additionally, the TX controller 114 may detect a reflected wave, and may demodulate a signal received from the target device 120 through an envelope of the reflected wave.

The TX controller 114 may generate a modulation signal for in-band communication using various schemes. To generate a modulation signal, the TX controller 114 may turn on or off the switching pulse signal used by the power amplifier 112, or may perform delta-sigma modulation. Additionally, the TX controller 114 may generate a pulse-width modulation (PWM) signal having a predetermined envelope.

The communication unit 115 may perform out-of-band communication using a communication channel. The communication unit 115 may include a communication module, such as a ZigBee module, a Bluetooth module, or any other communication module, that the communication unit 115 may use to perform the out-of-band communication. The communication unit 115 may transmit or receive data 140 to or from the target device 120 via the out-of-band communication.

The source resonator 131 transfers electromagnetic energy 130, such as the communication power or the charging power, to the target resonator 133 via a magnetic coupling with the target resonator 133.

The target resonator 133 receives the electromagnetic energy 130, such as the communication power or the charging power, from the source resonator 131 via a magnetic coupling with the source resonator 131. Additionally, the target resonator 133 receives various messages from the source device 110 via the in-band communication.

The matching network 121 matches an input impedance viewed from the source device 110 to an output impedance viewed from a load. The matching network 121 may be configured with a combination of a capacitor and an inductor.

The rectifier 122 generates a DC voltage by rectifying an AC voltage received by the target resonator 133.

The DC/DC converter 123 adjusts a level of the DC voltage output from the rectifier 122 based on a voltage rating of the load. For example, the DC/DC converter 123 may adjust the level of the DC voltage output from the rectifier 122 to a level in a range from 3 volts (V) to 10 V.

The power detector 127 detects a voltage (e.g., V_{dd}) of an input terminal 126 of the DC/DC converter 123, and a current and a voltage of an output terminal of the DC/DC converter 123. The power detector 127 outputs the detected voltage of the input terminal 126, and the detected current and the detected voltage of the output terminal, to the RX controller 125. The RX controller 125 uses the detected voltage of the input terminal 126 to compute a transmission efficiency of power received from the source device 110. Additionally, the RX controller 125 uses the detected current and the detected voltage of the output terminal to compute an amount of power transferred to the load. The TX controller 114 of the source device 110 determines an amount of power that needs to be transmitted by the source device 110 based on an amount of power required by the load and the amount of power transferred to the load. When the communication unit 124 transfers an amount of power of the output terminal (e.g., the computed amount of power transferred to the load) to the source device 110, the TX controller 114 of the source device 110 may compute the amount of power that needs to be transmitted by the source device 110.

The communication unit 124 may perform in-band communication for transmitting or receiving data using a resonance frequency by demodulating a received signal obtained by detecting a signal between the target resonator 133 and the rectifier 122, or by detecting an output signal of the rectifier 122. In other words, the RX controller 125 may demodulate a message received via the in-band communication.

Additionally, the RX controller 125 may adjust an impedance of the target resonator 133 to modulate a signal to be transmitted to the source device 110. For example, the RX controller 125 may increase the impedance of the target resonator so that a reflected wave will be detected by the TX controller 114 of the source device 110. In this example, depending on whether the reflected wave is detected, the TX controller 114 of the source device 110 will detect a binary number “0” or “1”.

The communication unit 124 may transmit, to the source device 110, any one or any combination of a response message including a product type of a corresponding target device, manufacturer information of the corresponding target device, a product model name of the corresponding target device, a battery type of the corresponding target device, a charging scheme of the corresponding target device, an impedance value of a load of the corresponding target device, information about a characteristic of a target resonator of the corresponding target device, information about a frequency band used the corresponding target device, an amount of power to be used by the corresponding target device, an intrinsic identifier of the corresponding target device, product version information of the corresponding target device, and standards information of the corresponding target device.

The communication unit 124 may also perform an out-of-band communication using a communication channel. The communication unit 124 may include a communication module, such as a ZigBee module, a Bluetooth module, or any other communication module known in the art, that the communication unit 124 may use to transmit or receive data 140 to or from the source device 110 via the out-of-band communication.

The communication unit 124 may receive a wake-up request message from the source device 110, detect an amount of a power received by the target resonator, and transmit, to the source device 110, information about the amount of the power received by the target resonator. In this example, the information about the amount of the power received by the target resonator may correspond to an input voltage value and an input current value of the rectifier 122, an output voltage value and an output current value of the rectifier 122, or an output voltage value and an output current value of the DC/DC converter 123.

The TX controller 114 sets a resonance bandwidth of the source resonator 131. Based on the resonance bandwidth of the source resonator 131, a Q-factor Q_{S} of the source resonator 131 is set.

The RX controller 125 sets a resonance bandwidth of the target resonator 133. Based on the resonance bandwidth of the target resonator 133, a Q-factor Q_{D} of the target resonator 133 is set. For example, the resonance bandwidth of the source resonator 131 may be set to be wider or narrower than the resonance bandwidth of the target resonator 133.

The source device 110 and the target device 120 communicate with each other to share information about the resonance bandwidth of the source resonator 131 and the resonance bandwidth of the target resonator 133. If power desired or needed by the target device 120 is greater than a reference value, the Q-factor Q_{S} of the source resonator 131 may be set to be greater than 100. If the power desired or needed by the target device 120 is less than the reference value, the Q-factor Q_{S} of the source resonator 131 may be set to less than 100.

In resonance-based wireless power transmission, a resonance bandwidth is a significant factor. If Qt indicates a Q-factor based on a change in a distance between the source resonator 131 and the target resonator 133, a change in a resonance impedance, impedance-mismatching, a reflected signal, or any other factor affecting a Q-factor, Qt is inversely proportional to a resonance bandwidth as expressed by the following Equation 1:

$$\begin{matrix}\frac{Δ f}{{f}_{0}} = \frac{1}{Qt} \\ = {Γ}_{S , D} + \frac{1}{{BW}_{S}} + \frac{1}{{BW}_{D}}\end{matrix} \qquad ( 1 )$$

In Equation 1, f₀ denotes a center frequency, Δf denotes a bandwidth, Γ_{S,D} denotes a reflection loss between resonators, BW_{S} denotes a resonance bandwidth of the source resonator 131, and BW_{D} denotes a resonance bandwidth of the target resonator 133.

An efficiency U of wireless power transmission may be expressed by the following Equation 2:

$$U = \frac{κ}{\sqrt{{Γ}_{S} {Γ}_{D}}} = \frac{{ω}_{0} M}{\sqrt{{R}_{S} {R}_{D}}} = \frac{\sqrt{{Q}_{S} {Q}_{D}}}{{Q}_{κ}} \qquad ( 2 )$$

In Equation 2, K denotes a coupling coefficient of energy coupling between the source resonator 131 and the target resonator 133, Γ_{S} denotes a reflection coefficient of the source resonator 131, Γ_{D} denotes a reflection coefficient of the target resonator 133, ω₀ denotes a resonance frequency, M denotes a mutual inductance between the source resonator 131 and the target resonator 133, R_{S} denotes an impedance of the source resonator 131, R_{D} denotes an impedance of the target resonator 133, Q_{S} denotes a Q-factor of the source resonator 131, Q_{D} denotes a Q-factor of the target resonator 133, and Q_{K} denotes a Q-factor of energy coupling between the source resonator 131 and the target resonator 133.

As can be seen from Equation 2, the Q-factor has a great effect on an efficiency of the wireless power transmission. Accordingly, the Q-factor may be set to a high value to increase the efficiency of the wireless power transmission. However, even when Q_{S} and Q_{D} are set to high values, the efficiency of the wireless power transmission may be reduced by a change in the coupling coefficient K of the energy coupling, a change in a distance between the source resonator 131 and the target resonator 133, a change in a resonance impedance, impedance mismatching, and any other factor affecting the efficiency of the wireless power transmission.

If the resonance bandwidths BW_{S} and BW_{D} of the source resonator 131 and the target resonator 133 are set to be too narrow to increase the efficiency of the wireless power transmission, impedance mismatching and other undesirable conditions may easily occur due to insignificant external influences. In order to account for the effect of impedance mismatching, Equation 1 may be rewritten as the following Equation 3:

$$\frac{Δ f}{{f}_{0}} = \frac{\sqrt{VSWR} - 1}{Qt \sqrt{VSWR}} \qquad ( 3 )$$

In an example in which an unbalanced relationship of a resonance bandwidth or a bandwidth of an impedance matching frequency between the source resonator 131 and the target resonator 133 is maintained, a reduction in efficiency of a wireless power transmission may be prevented due to a change in the coupling coefficient K, a change in the distance between the source resonator 131 and the target resonator 133, and/or a change in a resonance impedance and/or impedance mismatching. In an example in which the unbalanced relationship of the resonance bandwidth or the bandwidth of the impedance matching frequency between the source resonator 131 and the target resonator 133 is maintained, based on Equations 1 and 3, an unbalanced relationship between the Q-factors Q_{S} and Q_{D} may also be maintained.

The source device 110 wirelessly transmits wake-up power used to wake up the target device 120, and broadcasts a configuration signal used to configure a wireless power transmission network. The source device 110 further receives, from the target device 120, a search frame including a receiving sensitivity of the configuration signal, and may further permit a join of the target device 120. The source device 110 may further transmit, to the target device 120, an ID used to identify the target device 120 in the wireless power transmission network. The source device 110 may further generate the charging power through a power control, and may further wirelessly transmit the charging power to the target device 120.

The target device 120 receives wake-up power from at least one of source devices, and activates a communication function, using the wake-up power. The target device 120 further receives, from at least one of the source devices, a configuration signal used to configure a wireless power transmission network, and may further select the source device 110 based on a receiving sensitivity of the configuration signal. The target device 120 may further wirelessly receive power from the selected source device 110.

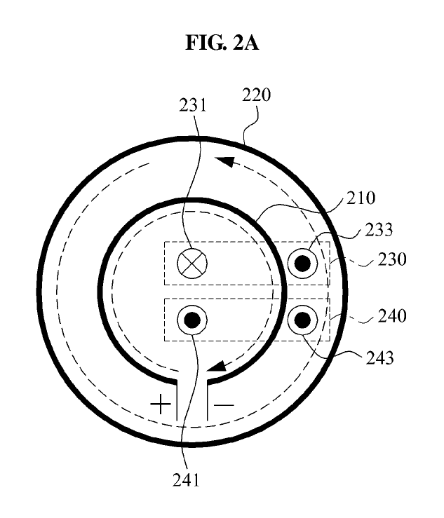

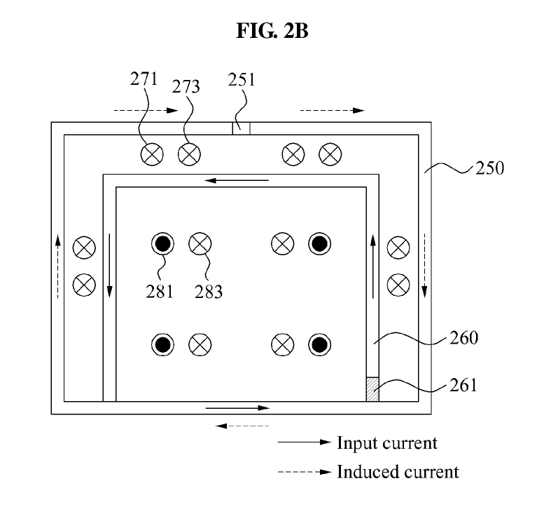

In the following description, the term “resonator” used in the discussion of FIGS. 2A through 4B refers to both a source resonator and a target resonator.

FIGS. 2A and 2B are diagrams illustrating examples of a distribution of a magnetic field in a feeder and a resonator of a wireless power transmitter. When a resonator receives power supplied through a separate feeder, magnetic fields are formed in both the feeder and the resonator.

FIG. 2A illustrates an example of a structure of a wireless power transmitter in which a feeder 210 and a resonator 220 do not have a common ground. Referring to FIG. 2A, as an input current flows into a feeder 210 through a terminal labeled “+” and out of the feeder 210 through a terminal labeled “−”, a magnetic field 230 is formed by the input current. A direction 231 of the magnetic field 230 inside the feeder 210 is into the plane of FIG. 2A, and has a phase that is opposite to a phase of a direction 233 of the magnetic field 230 outside the feeder 210. The magnetic field 230 formed by the feeder 210 induces a current to flow in a resonator 220. The direction of the induced current in the resonator 220 is opposite to a direction of the input current in the feeder 210 as indicated by the dashed arrows in FIG. 2A.

The induced current in the resonator 220 forms a magnetic field 240. Directions of the magnetic field 240 are the same at all positions inside the resonator 220. Accordingly, a direction 241 of the magnetic field 240 formed by the resonator 220 inside the feeder 210 has the same phase as a direction 243 of the magnetic field 240 formed by the resonator 220 outside the feeder 210.

Consequently, when the magnetic field 230 formed by the feeder 210 and the magnetic field 240 formed by the resonator 220 are combined, a strength of the total magnetic field inside the resonator 220 decreases inside the feeder 210 and increases outside the feeder 210. In an example in which power is supplied to the resonator 220 through the feeder 210 configured as illustrated in FIG. 2A, the strength of the total magnetic field decreases in the center of the resonator 220, but increases outside the resonator 220. In another example in which a magnetic field is randomly distributed in the resonator 220, it is difficult to perform impedance matching since an input impedance will frequently vary. Additionally, when the strength of the total magnetic field increases, an efficiency of wireless power transmission increases. Conversely, when the strength of the total magnetic field is decreases, the efficiency of wireless power transmission decreases. Accordingly, the power transmission efficiency may be reduced on average.

FIG. 2B illustrates an example of a structure of a wireless power transmitter in which a resonator 250 and a feeder 260 have a common ground. The resonator 250 includes a capacitor 251. The feeder 260 receives a radio frequency (RF) signal via a port 261. When the RF signal is input to the feeder 260, an input current is generated in the feeder 260. The input current flowing in the feeder 260 forms a magnetic field, and a current is induced in the resonator 250 by the magnetic field. Additionally, another magnetic field is formed by the induced current flowing in the resonator 250. In this example, a direction of the input current flowing in the feeder 260 has a phase opposite to a phase of a direction of the induced current flowing in the resonator 250. Accordingly, in a region between the resonator 250 and the feeder 260, a direction 271 of the magnetic field formed by the input current has the same phase as a direction 273 of the magnetic field formed by the induced current, and thus the strength of the total magnetic field increases in the region between the resonator 250 and the feeder 260. Conversely, inside the feeder 260, a direction 281 of the magnetic field formed by the input current has a phase opposite to a phase of a direction 283 of the magnetic field formed by the induced current, and thus the strength of the total magnetic field decreases inside the feeder 260. Therefore, the strength of the total magnetic field decreases in the center of the resonator 250, but increases outside the resonator 250.

An input impedance may be adjusted by adjusting an internal area of the feeder 260. The input impedance refers to an impedance viewed in a direction from the feeder 260 to the resonator 250. When the internal area of the feeder 260 is increased, the input impedance is increased. Conversely, when the internal area of the feeder 260 is decreased, the input impedance is decreased. Because the magnetic field is randomly distributed in the resonator 250 despite a reduction in the input impedance, a value of the input impedance may vary based on a location of a target device. Accordingly, a separate matching network may be required to match the input impedance to an output impedance of a power amplifier. For example, when the input impedance is increased, a separate matching network may be used to match the increased input impedance to a relatively low output impedance of the power amplifier.

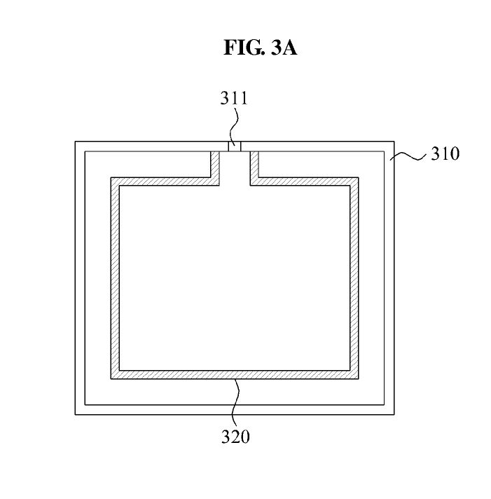

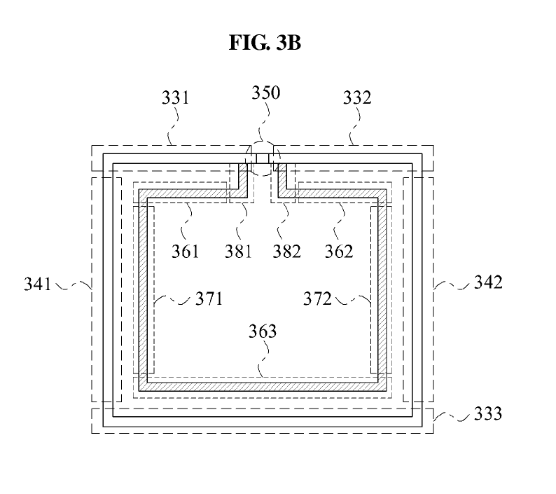

FIGS. 3A and 3B are diagrams illustrating an example of a feeding unit and a resonator of a wireless power transmitter. Referring to FIG. 3A, the wireless power transmitter includes a resonator 310 and a feeding unit 320. The resonator 310 further includes a capacitor 311. The feeding unit 320 is electrically connected to both ends of the capacitor 311.

FIG. 3B illustrates, in greater detail, a structure of the wireless power transmitter of FIG. 3A. The resonator 310 includes a first transmission line (not identified by a reference numeral in FIG. 3B, but formed by various elements in FIG. 3B as discussed below), a first conductor 341, a second conductor 342, and at least one capacitor 350.

The capacitor 350 is inserted in series between a first signal conducting portion 331 and a second signal conducting portion 332, causing an electric field to be confined within the capacitor 350. Generally, a transmission line includes at least one conductor in an upper portion of the transmission line, and at least one conductor in a lower portion of first transmission line. A current may flow through the at least one conductor disposed in the upper portion of the first transmission line, and the at least one conductor disposed in the lower portion of the first transmission line may be electrically grounded. In this example, a conductor disposed in an upper portion of the first transmission line in FIG. 3B is separated into two portions that will be referred to as the first signal conducting portion 331 and the second signal conducting portion 332. A conductor disposed in a lower portion of the first transmission line in FIG. 3B will be referred to as a first ground conducting portion 333.

As illustrated in FIG. 3B, the resonator 310 has a generally two-dimensional (2D) structure. The first transmission line includes the first signal conducting portion 331 and the second signal conducting portion 332 in the upper portion of the first transmission line, and includes the first ground conducting portion 333 in the lower portion of the first transmission line. The first signal conducting portion 331 and the second signal conducting portion 332 are disposed to face the first ground conducting portion 333. A current flows through the first signal conducting portion 331 and the second signal conducting portion 332.

One end of the first signal conducting portion 331 is connected to one end of the first conductor 341, the other end of the first signal conducting portion 331 is connected to the capacitor 350, and the other end of the first conductor 341 is connected to one end of the first ground conducting portion 333. One end of the second signal conducting portion 332 is connected to one end of the second conductor 342, the other end of the second signal conducting portion 332 is connected to the other end of the capacitor 350, and the other end of the second conductor 342 is connected to the other end of the ground conducting portion 333. Accordingly, the first signal conducting portion 331, the second signal conducting portion 332, the first ground conducting portion 333, the first conductor 341, and the second conductor 342 are connected to each other, causing the resonator 310 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

The capacitor 350 is inserted into an intermediate portion of the first transmission line. In the example in FIG. 3B, the capacitor 350 is inserted into a space between the first signal conducting portion 331 and the second signal conducting portion 332. The capacitor 350 may be a lumped element capacitor, a distributed capacitor, or any other type of capacitor known to one of ordinary skill in the art. For example, a distributed element capacitor may include a zigzagged conductor line and a dielectric material having a relatively high permittivity disposed between parallel portions of the zigzagged conductor line.

The capacitor 350 inserted into the first transmission line may cause the resonator 310 to have a characteristic of a metamaterial. A metamaterial is a material having a predetermined electrical property that is not found in nature, and thus may have an artificially designed structure. All materials existing in nature have a magnetic permeability and permittivity. Most materials have a positive magnetic permeability and/or a positive permittivity.

For most materials, a right-hand rule may be applied to an electric field, a magnetic field, and a Poynting vector of the materials, so the materials may be referred to as right-handed materials (RHMs). However, a metamaterial that has a magnetic permeability and/or a permittivity that is not found in nature, and may be classified into an epsilon negative (ENG) material, a mu negative (MNG) material, a double negative (DNG) material, a negative refractive index (NRI) material, a left-handed (LH) material, and other metamaterial classifications known to one of ordinary skill in the art based on a sign of the magnetic permeability of the metamaterial and a sign of the permittivity of the metamaterial.

If the capacitor 350 is a lumped element capacitor and a capacitance of the capacitor 350 is appropriately determined, the resonator 310 may have a characteristic of a metamaterial. If the resonator 310 is caused to have a negative magnetic permeability by appropriately adjusting the capacitance of the capacitor 350, the resonator 310 may also be referred to as an MNG resonator. Various criteria may be applied to determine the capacitance of the capacitor 350. For example, the various criteria may include a criterion for enabling the resonator 310 to have the characteristic of the metamaterial, a criterion for enabling the resonator 310 to have a negative magnetic permeability at a target frequency, a criterion for enabling the resonator 310 to have a zeroth order resonance characteristic at the target frequency, and any other suitable criterion. Based on any one or any combination of the aforementioned criteria, the capacitance of the capacitor 350 may be appropriately determined.

The resonator 310, hereinafter referred to as the MNG resonator 310, may have a zeroth order resonance characteristic of having a resonance frequency when a propagation constant is “0”. If the MNG resonator 310 has the zeroth order resonance characteristic, the resonance frequency is independent of a physical size of the MNG resonator 310. By changing the capacitance of the capacitor 350, the resonance frequency of the MNG resonator 310 may be changed without changing the physical size of the MNG resonator 310.

In a near field, the electric field is concentrated in the capacitor 350 inserted into the first transmission line, causing the magnetic field to become dominant in the near field. The MNG resonator 310 has a relatively high Q-factor when the capacitor 350 is a lumped element, thereby increasing a power transmission efficiency. The Q-factor indicates a level of an ohmic loss or a ratio of a reactance with respect to a resistance in the wireless power transmission. As will be understood by one of ordinary skill in the art, the efficiency of the wireless power transmission will increase as the Q-factor increases.

Although not illustrated in FIG. 3B, a magnetic core passing through the MNG resonator 310 may be provided to increase a power transmission distance.

Referring to FIG. 3B, the feeding unit 320 includes a second transmission line (not identified by a reference numeral in FIG. 3B, but formed by various elements in FIG. 3B as discussed below), a third conductor 371, a fourth conductor 372, a fifth conductor 381, and a sixth conductor 382.

The second transmission line includes a third signal conducting portion 361 and a fourth signal conducting portion 362 in an upper portion of the second transmission line, and includes a second ground conducting portion 363 in a lower portion of the second transmission line. The third signal conducting portion 361 and the fourth signal conducting portion 362 are disposed to face the second ground conducting portion 363. A current flows through the third signal conducting portion 361 and the fourth signal conducting portion 362.

One end of the third signal conducting portion 361 is connected to one end of the third conductor 371, the other end of the third signal conducting portion 361 is connected to one end of the fifth conductor 381, and the other end of the third conductor 371 is connected to one end of the second ground conducting portion 363. One end of the fourth signal conducting portion 362 is connected to one end of the fourth conductor 372, the other end of the fourth signal conducting portion 362 is connected to one end the sixth conductor 382, and the other end of the fourth conductor 372 is connected to the other end of the second ground conducting portion 363. The other end of the fifth conductor 381 is connected to the first signal conducting portion 331 at or near where the first signal conducting portion 331 is connected to one end of the capacitor 350, and the other end of the sixth conductor 382 is connected to the second signal conducting portion 332 at or near where the second signal conducting portion 332 is connected to the other end of the capacitor 350. Thus, the fifth conductor 381 and the sixth conductor 382 are connected in parallel to both ends of the capacitor 350. The fifth conductor 381 and the sixth conductor 382 are used as an input port to receive an RF signal as an input.

Accordingly, the third signal conducting portion 361, the fourth signal conducting portion 362, the second ground conducting portion 363, the third conductor 371, the fourth conductor 372, the fifth conductor 381, the sixth conductor 382, and the resonator 310 are connected to each other, causing the resonator 310 and the feeding unit 320 to have an electrically closed loop structure. The term “loop structure” includes a polygonal structure, a circular structure, a rectangular structure, and any other geometrical structure that is closed, i.e., that does not have any opening in its perimeter. The expression “having a loop structure” indicates a structure that is electrically closed.

If an RF signal is input to the fifth conductor 381 or the sixth conductor 382, input current flows through the feeding unit 320 and the resonator 310, generating a magnetic field that induces a current in the resonator 310. A direction of the input current flowing through the feeding unit 320 is identical to a direction of the induced current flowing through the resonator 310, thereby causing a strength of a total magnetic field to increase in the center of the resonator 310, and decrease near the outer periphery of the resonator 310.

An input impedance is determined by an area of a region between the resonator 310 and the feeding unit 320. Accordingly, a separate matching network used to match the input impedance to an output impedance of a power amplifier may not be necessary. However, if a matching network is used, the input impedance may be adjusted by adjusting a size of the feeding unit 320, and accordingly a structure of the matching network may be simplified. The simplified structure of the matching network may reduce a matching loss of the matching network.

The second transmission line, the third conductor 371, the fourth conductor 372, the fifth conductor 381, and the sixth conductor 382 of the feeding unit may have a structure identical to the structure of the resonator 310. For example, if the resonator 310 has a loop structure, the feeding unit 320 may also have a loop structure. As another example, if the resonator 310 has a circular structure, the feeding unit 320 may also have a circular structure.

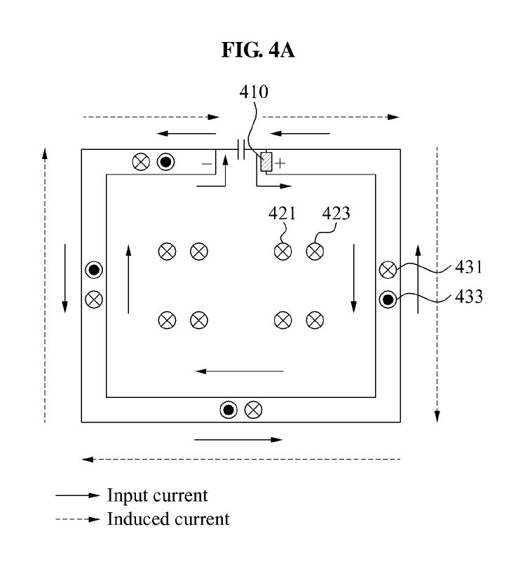

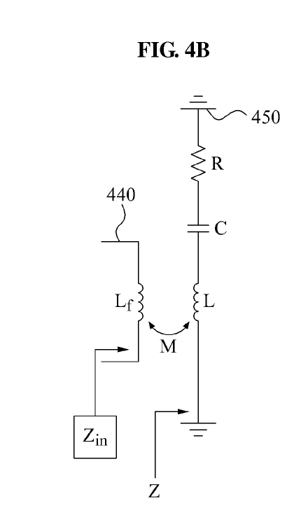

FIG. 4A is a diagram illustrating an example of a distribution of a magnetic field in a resonator that is produced by feeding of a feeding unit, of a wireless power transmitter. FIG. 4A more simply illustrates the resonator 310 and the feeding unit 320 of FIGS. 3A and 3B, and the names of the various elements in FIG. 3B will be used in the following description of FIG. 4A without reference numerals.

A feeding operation may be an operation of supplying power to a source resonator in wireless power transmission, or an operation of supplying AC power to a rectifier in wireless power transmission. FIG. 4A illustrates a direction of input current flowing in the feeding unit, and a direction of induced current flowing in the source resonator. Additionally, FIG. 4A illustrates a direction of a magnetic field formed by the input current of the feeding unit, and a direction of a magnetic field formed by the induced current of the source resonator.

Referring to FIG. 4A, the fifth conductor or the sixth conductor of the feeding unit 320 may be used as an input port 410. In FIG. 4A, the sixth conductor of the feeding unit is being used as the input port 410. An RF signal is input to the input port 410. The RF signal may be output from a power amplifier. The power amplifier may increase and decrease an amplitude of the RF signal based on a power requirement of a target device. The RF signal input to the input port 410 is represented in FIG. 4A as an input current flowing in the feeding unit. The input current flows in a clockwise direction in the feeding unit along the second transmission line of the feeding unit. The fifth conductor and the sixth conductor of the feeding unit are electrically connected to the resonator. More specifically, the fifth conductor of the feeding unit is connected to the first signal conducting portion of the resonator, and the sixth conductor of the feeding unit is connected to the second signal conducting portion of the resonator. Accordingly, the input current flows in both the resonator and the feeding unit. The input current flows in a counterclockwise direction in the resonator along the first transmission line of the resonator. The input current flowing in the resonator generates a magnetic field, and the magnetic field induces a current in the resonator due to the magnetic field. The induced current flows in a clockwise direction in the resonator along the first transmission line of the resonator. The induced current in the resonator transfers energy to the capacitor of the resonator, and also generates a magnetic field. In FIG. 4A, the input current flowing in the feeding unit and the resonator is indicated by solid lines with arrowheads, and the induced current flowing in the resonator is indicated by dashed lines with arrowheads.

A direction of a magnetic field generated by a current is determined based on the right-hand rule. As illustrated in FIG. 4A, within the feeding unit, a direction 421 of the magnetic field generated by the input current flowing in the feeding unit is identical to a direction 423 of the magnetic field generated by the induced current flowing in the resonator. Accordingly, a strength of the total magnetic field may increases inside the feeding unit.

In contrast, as illustrated in FIG. 4A, in a region between the feeding unit and the resonator, a direction 433 of the magnetic field generated by the input current flowing in the feeding unit is opposite to a direction 431 of the magnetic field generated by the induced current flowing in the resonator. Accordingly, the strength of the total magnetic field decreases in the region between the feeding unit and the resonator.

Typically, in a resonator having a loop structure, a strength of a magnetic field decreases in the center of the resonator, and increases near an outer periphery of the resonator. However, referring to FIG. 4A, since the feeding unit is electrically connected to both ends of the capacitor of the resonator, the direction of the induced current in the resonator is identical to the direction of the input current in the feeding unit. Since the direction of the induced current in the resonator is identical to the direction of the input current in the feeding unit, the strength of the total magnetic field increases inside the feeding unit, and decreases outside the feeding unit. As a result, due to the feeding unit, the strength of the total magnetic field increases in the center of the resonator having the loop structure, and decreases near an outer periphery of the resonator, thereby compensating for the normal characteristic of the resonator having the loop structure in which the strength of the magnetic field decreases in the center of the resonator, and increases near the outer periphery of the resonator. Thus, the strength of the total magnetic field may be constant inside the resonator.

A power transmission efficiency for transferring wireless power from a source resonator to a target resonator is proportional to the strength of the total magnetic field generated in the source resonator. Accordingly, when the strength of the total magnetic field increases inside the source resonator, the power transmission efficiency also increases.

FIG. 4B is a diagram illustrating examples of equivalent circuits of a feeding unit and a resonator of a wireless power transmitter. Referring to FIG. 4B, a feeding unit 440 and a resonator 450 may be represented by the equivalent circuits in FIG. 4B. The feeding unit 440 is represented as an inductor having an inductance L_{f}, and the resonator 450 is represented as a series connection of an inductor having an inductance L coupled to the inductance L_{f} of the feeding unit 440 by a mutual inductance M, a capacitor having a capacitance C, and a resistor having a resistance R. An example of an input impedance Zᵢₙ viewed in a direction from the feeding unit 440 to the resonator 450 may be expressed by the following Equation 4:

$${Z}_{i n} = \frac{{( ω M )}^{2}}{Z} \qquad ( 4 )$$

In Equation 4, M denotes a mutual inductance between the feeding unit 440 and the resonator 450, ω denotes a resonance frequency of the feeding unit 440 and the resonator 450, and Z denotes an impedance viewed in a direction from the resonator 450 to a target device. As can be seen from Equation 4, the input impedance Zᵢₙ is proportional to the square of the mutual inductance M. Accordingly, the input impedance Zᵢₙ may be adjusted by adjusting the mutual inductance M. The mutual inductance M depends on an area of a region between the feeding unit 440 and the resonator 450. The area of the region between the feeding unit 440 and the resonator 450 may be adjusted by adjusting a size of the feeding unit 440, thereby adjusting the mutual inductance M and the input impedance Zᵢₙ. Since the input impedance Zᵢₙ may be adjusted by adjusting the size of the feeding unit 440, it may be unnecessary to use a separate matching network to perform impedance matching with an output impedance of a power amplifier.

In a target resonator and a feeding unit included in a wireless power receiver, a magnetic field may be distributed as illustrated in FIG. 4A. For example, the target resonator may receive wireless power from a source resonator via magnetic coupling. The received wireless power induces a current in the target resonator. The induced current in the target resonator generates a magnetic field, which induces a current in the feeding unit. If the target resonator is connected to the feeding unit as illustrated in FIG. 4A, a direction of the induced current flowing in the target resonator will be identical to a direction of the induced current flowing in the feeding unit. Accordingly, for the reasons discussed above in connection with FIG. 4A, a strength of the total magnetic field will increase inside the feeding unit, and will decrease in a region between the feeding unit and the target resonator.

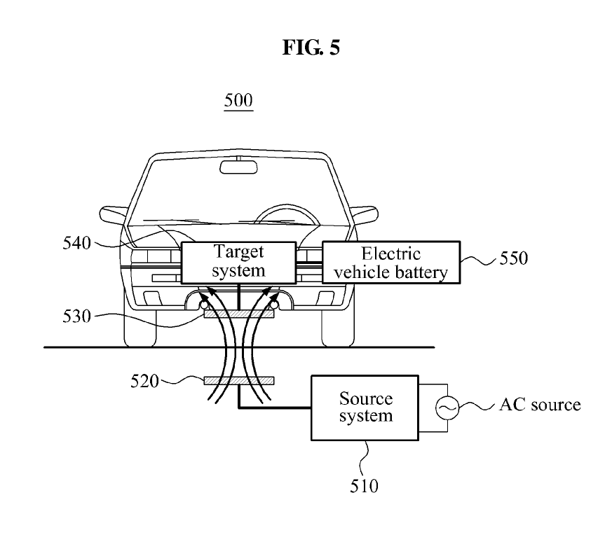

FIG. 5 is a diagram illustrating an example of an electric vehicle charging system. Referring to FIG. 5, an electric vehicle charging system 500 includes a source system 510, a source resonator 520, a target resonator 530, a target system 540, and an electric vehicle battery 550.

In one example, the electric vehicle charging system 500 includes a structure similar to the structure of the wireless power transmission system of FIG. 1. The source system 510 and the source resonator 520 in the electric vehicle charging system 500 operate as a source. The target resonator 530 and the target system 540 in the electric vehicle charging system 500 operate as a target.

In one example, the source system 510 includes an alternating current-to-direct current (AC/DC) converter, a power detector, a power converter, a control and communication (control/communication) unit similar to those of the source device 110 of FIG. 1. In one example, the target system 540 includes a rectifier, a DC-to-DC (DC/DC) converter, a switch, a charging unit, and a control/communication unit similar to those of the target device 120 of FIG. 1. The electric vehicle battery 550 is charged by the target system 540. The electric vehicle charging system 500 may use a resonant frequency in a band of a few kHz to tens of MHz.

The source system 510 generates power based on a type of the vehicle being charged, a capacity of the electric vehicle battery 550, and a charging state of the electric vehicle battery 550, and wirelessly transmits the generated power to the target system 540 via a magnetic coupling between the source resonator 520 and the target resonator 530.

The source system 510 may control an alignment of the source resonator 520 and the target resonator 530. For example, when the source resonator 520 and the target resonator 530 are not aligned, the controller of the source system 510 may transmit a message to the target system 540 to control the alignment of the source resonator 520 and the target resonator 530.

For example, when the target resonator 530 is not located in a position enabling maximum magnetic coupling, the source resonator 520 and the target resonator 530 are not properly aligned. When a vehicle does not stop at a proper position to accurately align the source resonator 520 and the target resonator 530, the source system 510 may instruct a position of the vehicle to be adjusted to control the source resonator 520 and the target resonator 530 to be aligned. However, this is just an example, and other methods of aligning the source resonator 520 and the target resonator 530 may be used.

The source system 510 and the target system 540 may transmit or receive an ID of a vehicle and exchange various messages by performing communication with each other.

The descriptions of FIGS. 1 through 4B are also applicable to the electric vehicle charging system 500. However, the electric vehicle charging system 500 may use a resonant frequency in a band of a few kHz to tens of MHz, and may wirelessly transmit power that is equal to or higher than tens of watts to charge the electric vehicle battery 550.

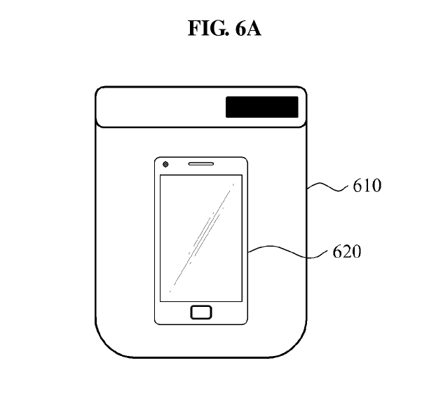

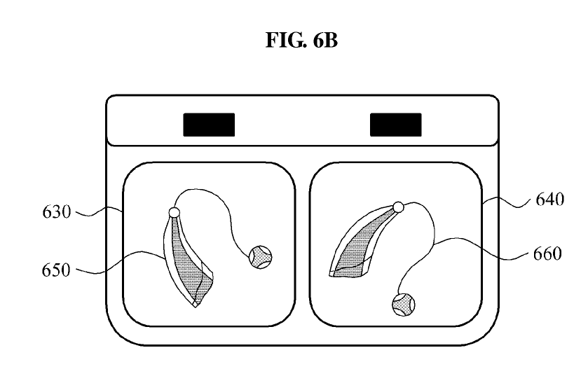

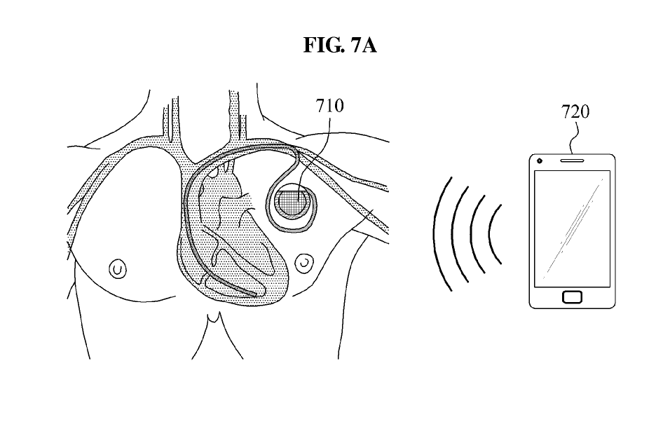

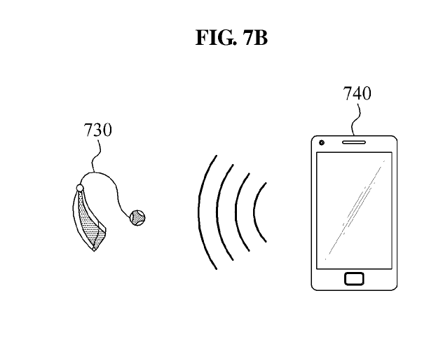

FIGS. 6A through 7B are diagrams illustrating examples of applications in which a wireless power receiver and a wireless power transmitter are mounted. FIG. 6A illustrates an example of wireless power charging between a pad 610 and a mobile terminal 620, and FIG. 6B illustrates an example of wireless power charging between pads 630 and 640 and hearing aids 650 and 660, respectively.

Referring to FIG. 6A, a wireless power transmitter is mounted in the pad 610, and a wireless power receiver is mounted in the mobile terminal 620. The pad 610 charges a single mobile terminal, namely, the mobile terminal 620.

Referring to FIG. 6B, two wireless power transmitters are respectively mounted in the pads 630 and 640. The hearing aids 650 and 660 are used for a left ear and a right ear, respectively. Two wireless power receivers are respectively mounted in the hearing aids 650 and 660. The pads 630 and 640 charge two hearing aids, respectively, namely, the hearing aids 650 and 660.

FIG. 7A illustrates an example of wireless power charging between an electronic device 710 inserted into a human body, and a mobile terminal 720. FIG. 7B illustrates an example of wireless power charging between a hearing aid 730 and a mobile terminal 740.

Referring to FIG. 7A, a wireless power transmitter and a wireless power receiver are mounted in the mobile terminal 720. Another wireless power receiver is mounted in the electronic device 710. The electronic device 710 is charged by receiving power from the mobile terminal 720.

Referring to FIG. 7B, a wireless power transmitter and a wireless power receiver are mounted in the mobile terminal 740. Another wireless power receiver is mounted in the hearing aid 730. The hearing aid 730 is charged by receiving power from the mobile terminal 740. Low-power electronic devices, for example, Bluetooth earphones, may also be charged by receiving power from the mobile terminal 740.

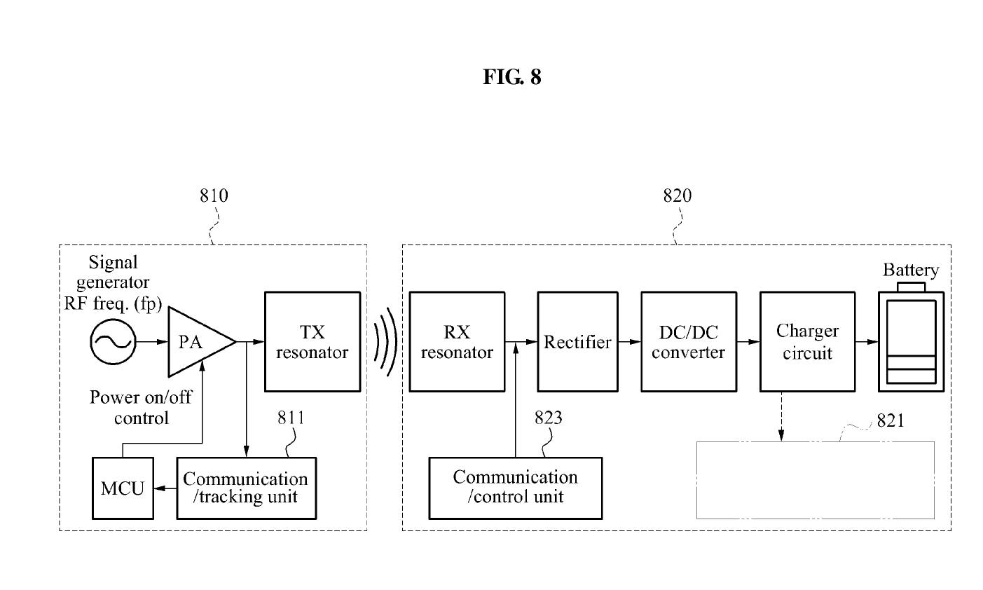

FIG. 8 is a diagram illustrating another example of a wireless power transmission system. Referring to FIG. 8, a wireless power transmitter 810 may be mounted in each of the pad 610 of FIG. 6A and pads 630 and 640 of FIG. 6B. Additionally, the wireless power transmitter 810 may be mounted in each of the mobile terminal 720 of FIG. 7A and the mobile terminal 740 of FIG. 7B.

In addition, a wireless power receiver 820 may be mounted in each of the mobile terminal 620 of FIG. 6A and the hearing aids 650 and 660 of FIG. 6B. Further, the wireless power receiver 820 may be mounted in each of the electronic device 710 of FIG. 7A and the hearing aid 730 of FIG. 7B.

The wireless power transmitter 810 may include a similar configuration to the source device 110 of FIG. 1. For example, the wireless power transmitter 810 may include a unit configured to transmit power using magnetic coupling.

Referring to FIG. 8, the wireless power transmitter 810 includes a signal generator that generates a radio frequency (RF) frequency fp, a power amplifier (PA), a microcontroller unit (MCU), a source resonator, and a communication/tracking unit 811. The communication/tracking unit 811 communicates with the wireless power receiver 820, and controls an impedance and a resonance frequency to maintain a wireless power transmission efficiency. Additionally, the communication/tracking unit 811 may perform similar functions to the communication unit 115 of FIG. 1.

The wireless power receiver 820 may include a similar configuration to the target device 120 of FIG. 1. For example, the wireless power receiver 820 may include a unit configured to wirelessly receive power and to charge a battery.

Referring to FIG. 8, the wireless power receiver 820 includes a target resonator, a rectifier, a DC/DC converter, a charger circuit, and a communication/control unit 823. The communication/control unit 823 communicates with the wireless power transmitter 810, and performs an operation to protect overvoltage and overcurrent.

The wireless power receiver 820 may include a hearing device circuit 821. The hearing device circuit 821 may be charged by a battery. The hearing device circuit 821 may include, for example, a microphone, an analog-to-digital converter (ADC), a processor, a digital-to-analog converter (DAC), and/or a receiver. For example, the hearing device circuit 821 may include the same configuration as a hearing aid.

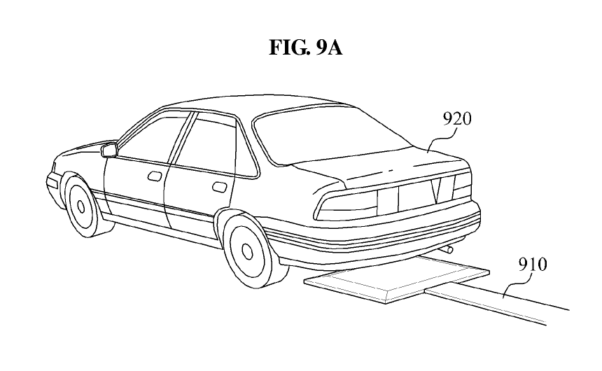

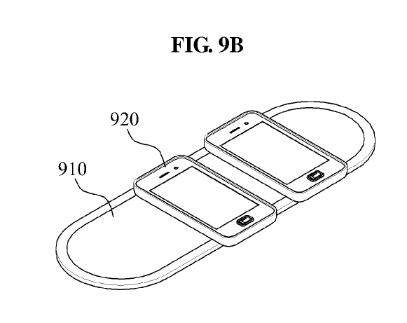

FIGS. 9A and 9B are diagrams illustrating examples of a pad-type wireless power transmission system. In a pad-type wireless power transmission circumstance, a state of misalignment, and a distance between a wireless power transmitter 910 and a wireless power receiver 920, may remain unchanged from a beginning of charging to an end of the charging. In this example, the wireless power receiver 920 may be charged stably until the charging is terminated, due to the constant transmission circumstance, when whether a charging circumstance is appropriate is determined in the beginning of the charging.

A degree of misalignment and/or the distance between the wireless power transmitter 910 and the wireless power receiver 920 may have an influence on an efficiency of the pad-type wireless power transmission system. Since it may be difficult to technically use a power transceiver with high efficiency in all fields, a power transceiver with a limited characteristic, for example, a limited transmission efficiency, based on an application may be used.

In an example in which the wireless power transmission circumstance is changed, that is, the degree of misalignment and/or the distance between the wireless power transmitter 910 and the wireless power receiver 920 are changed, a charging circumstance may not satisfy a predetermined condition of the wireless power transmission system to charge the wireless power receiver 920. In this example, when the charging circumstance does not satisfy the predetermined condition, charging may be stopped, and/or a warning may be provided to a user (of the wireless power transmitter 910 and/or the wireless power receiver 920) that notifies the user of the charging being stopped.

In the pad-type wireless power transmission system for an electric vehicle and a smart device, as illustrated in FIGS. 9A and 9B, respectively, the degree of misalignment and the distance between the wireless power transmitter 910 and the wireless power receiver 920 that are measured when charging is started may be almost identical to the degree of misalignment and the distance between the wireless power transmitter 910 and the wireless power receiver 920 that are measured when the charging is completed. That is, in the pad-type wireless power transmission system, an example in which the charging circumstance does not satisfy the predetermined condition may hardly occur.

In the pad-type wireless power transmission system, wireless power transmission information of a degree of misalignment and/or a charging distance of the system may be acquired prior to a beginning of a charging. The pad-type wireless power transmission system may determine whether an appropriate charging circumstance is provided based on the wireless power transmission information, and may determine whether to perform the charging based on a result of the determination of whether the appropriate charging circumstance is provided. The wireless power transmission information may include, for example, a change in an impedance of a load device included in the wireless power receiver 920, a change in a coupling coefficient between the wireless power transmitter 910 and the wireless power receiver 920, and/or a change in a voltage gain.

For example, to determine whether a charging circumstance satisfies a predetermined condition, a scheme of checking an impedance of a load device included in the wireless power receiver 920, and a scheme of using a voltage gain curve based on a coupling coefficient K between the wireless power transmitter 910 and the wireless power receiver 920, may be used. The above schemes may enable a variety of information used to determine the charging circumstance to be acquired by controlling an operating frequency of the pad-type wireless power transmission system, prior to a beginning of charging. In an example, a change in an impedance, in a coupling coefficient, and/or in a voltage gain may be detected, while the operating frequency is sequentially changed within a frequency band of a predetermined range.

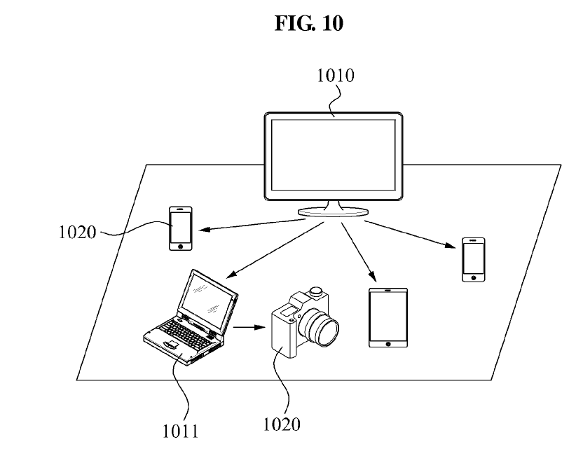

FIG. 10 is a diagram illustrating an example of a space-type wireless power transmission system. Referring to FIG. 10, a wireless power transmitter 1010 transmits power to a wireless power transmitter 1011 (e.g., a laptop), and the wireless power transmitter 1011 may transmit the power to wireless power receivers 1020 (e.g., a camera and/or a smart device).

In a space-type wireless power transmission circumstance, as illustrated in FIG. 10, a degree of misalignment and/or a distance between the wireless power transmitter 1010 and each of the wireless power receivers 1020 may continue to be changed, even when charging is performed. Accordingly, it may be difficult to perform a normal charging process. The space-type wireless power transmission system of FIG. 10 may determine, in real time, whether the space-type wireless power transmission circumstance is appropriate to perform charging, and determine whether to perform the charging based on whether the circumstance is appropriate.

The space-type wireless power transmission circumstance may be spatially changed, not just two-dimensionally changed. For example, as illustrated in FIG. 10, for the wireless power transmitter 1010, for example, a monitor, the wireless power receivers 1020 may exist in space. The wireless power receivers 1020 may include various load devices, for example, a keyboard, a mobile phone, a speaker, and/or other device known to one of ordinary skill in the art. In this example, various wireless power transmission circumstances may be generated and changed between the wireless power transmitter 1010 and the wireless power receivers 1020.

In an example in which a user uses a mobile phone, a location of the mobile phone from a monitor may continue to be changed. Based on a change in the location, load power, the degree of misalignment, and the distance between the wireless power transmitter 1010 and each of the wireless power receivers 1020, may continue to be changed. The load power may be controlled based on a power control of the wireless power transmitter 1010; however, it may be difficult to control a change in the degree of misalignment and the distance between the wireless power transmitter 1010 and each of the wireless power receivers 1020. In this example, the wireless power transmission system may need to control a charging process to be performed in an appropriate charging circumstance only.

As described above with reference to FIGS. 9A and 9B, whether a charging circumstance satisfies a predetermined condition may be determined based on a change in an impedance, a change in a coupling coefficient, and/or a change in a voltage gain curve. However, the above scheme may be applied to only a pad-type wireless power transmission system.

In the space-type wireless power transmission circumstance, the degree of misalignment and/or the distance between the wireless power transmitter 1010 and each of the wireless power receivers 1020, may continue to be changed during the charging, even when whether the charging circumstance satisfies the predetermined condition is determined in the beginning of the charging. For example, to determine the charging circumstance based on the change in the impedance, the change in the coupling coefficient, and/or the change in the voltage gain curve, an operating frequency may be repeatedly controlled to detect a change in the charging circumstance during the charging. In this example, the charging may be discontinuously performed. Additionally, when the charging circumstance is changed during the control of the operating frequency, it may be difficult to accurately determine the charging circumstance.

In addition, in a scheme of using a change in an impedance and/or a voltage gain curve, it may be difficult to set a criterion when a coupling coefficient is reduced due to an increase in a distance between the wireless power transmitter 1010 and one of the wireless power receivers 1020, for example. For example, in a scheme of using a voltage gain curve, a charging circumstance may be determined based on a voltage gain value in an inflection point frequency or an inflection point frequency value of a voltage gain curve represented regardless of load power. In this example, when a wireless power transmission system has a low coupling coefficient, an inflection point frequency of a voltage gain curve based on load power may converge near a single frequency. Additionally, since a change in a voltage gain value in the inflection point frequency is increased due to the convergence of the inflection point frequency, it may be difficult to determine the charging circumstance.

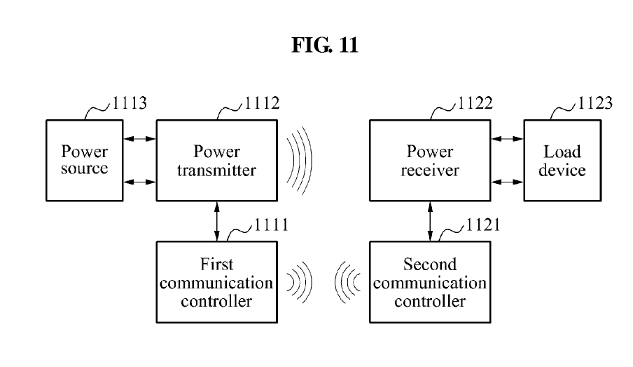

FIG. 11 is a diagram illustrating still another example of a wireless power transmission system. In FIG. 11, a wireless power transmitter includes a first communication controller 1111, a power transmitter 1112, and a power source 1113, and a wireless power receiver includes a second communication controller 1121, a power receiver 1122, and a load device 1123.

The wireless power transmission system of FIG. 11 (e.g., the first communication controller 1111 and/or the second communication controller 1121) may determine a charging circumstance based on a power transfer efficiency between the wireless power transmitter and the wireless power receiver. When charging is being performed between the wireless power transmitter and the wireless power receiver, the wireless power receiver continuously detects power detection information to be used to determine the charging circumstance, and may continuously transmit the power detection information to the wireless power transmitter.

The power detection information may be electrical information, and may include information measured at a front end of a DC/DC converter of the wireless power receiver, for example, current, voltage, and/or power measured at the front end of the DC/DC converter. In addition, the power detection information may be detected between a rectifier and the DC/DC converter of the wireless power receiver. The power transfer efficiency may include, for example, a voltage ratio, a current ratio, and/or a power ratio between the wireless power transmitter and the wireless power receiver, and/or a ratio of voltage, current, and/or power received by the wireless power receiver from the wireless power transmitter, to reference voltage, reference current, and/or reference power, respectively. That is, the power transfer efficiency may include a ratio of the current, voltage, and/or power measured at the front end of the DC/DC converter, to current, voltage, and/or power, respectively, which are measured in the wireless power transmitter. In alternative to the power transfer efficiency, the charging circumstance may be information computed based on the power detection information, and may include, for example, current, voltage, and/or power received by the wireless power receiver from the wireless power transmitter. Unlike an example in which a voltage gain curve is used in a wireless power transmission system with a low coupling coefficient, the charging circumstance may be easily determined regardless of convergence of an inflection point frequency.

The wireless power transmission system (e.g., the first communication controller 1111 and/or the second communication controller 1121) determines whether the charging circumstance satisfies a predetermined condition, despite a change in a charging distance and a misalignment degree between the wireless power transmitter and the wireless power receiver. The wireless power transmission system (e.g., the first communication controller 1111 and/or the second communication controller 1121) determines whether to maintain the charging based on whether the charging circumstance satisfies the predetermined condition, and may provide a user (of the wireless power transmitter and/or the wireless power receiver) with a warning, for example, a notification of the charging circumstance (e.g., the charging being stopped).

The predetermined condition may be set based on a performance needed by an application included in the load device 1123. In an example in which the load device 1123 needs voltage of a predetermined range, the predetermined condition may be set to need the voltage detected from the front end of the DC/DC converter of the wireless power receiver to be within a predetermined range, for example, a range of about 1 V to 10 V. In another example in which the load device 1123 needs current of a predetermined range and voltage of a predetermined range, the predetermined condition may be set to need the current and the voltage detected from the front end of the DC/DC converter to be within predetermined ranges, for example, a range of about 1 A to 4 A, and a range of about 1 V to 10 V, respectively. In still another example in which the load device 1123 needs a power transmission efficiency of a predetermined range, the predetermined condition may be set to need a ratio of power of the wireless power transmitter to power detected from the front end of the DC/DC converter to be within a predetermined range, for example, a range of about 60% to 100%.

For example, when the wireless power receiver detects and transmits the detected power detection information to the wireless power transmitter, the wireless power transmitter may compare internal power information with the received power detection information, and may determine the charging circumstance of the wireless power transmission system based on the comparison. By determining the charging circumstance based on the power detection information received from the wireless power receiver, the wireless power transmitter may remove uncertainty occurring when the charging circumstance is determined using only the internal power information, for example, current, voltage, and power measured at each end of a circuit included in the wireless power transmitter. In an example in which a single wireless power transmitter and a single wireless power receiver are two-dimensionally located, a small error may occur in determining a charging circumstance, despite the charging circumstance being determined based on only internal power information in the wireless power transmitter. However, when power detection information of a wireless power receiver is not taken into consideration in a space-type wireless power transmission system, an error in determining a charging circumstance may be increased.

Referring to FIG. 11, the first communication controller 1111 recognizes the load device 1123. When the load device 1123 is recognized, the first communication controller 1111 receives, from the second communication controller 1121, power detection information detected by the wireless power receiver (e.g., the second communication controller 1121) from a front end of a DC/DC converter included in the power receiver 1122. The first communication controller 1111 determines a charging circumstance of the load device 1123 based on the power detection information, and determines whether the charging circumstance satisfies a predetermined condition. The charging circumstance of the load device 1123 may be information computed based on the power detection information, and may include, for example, current, voltage, and/or power received by the wireless power receiver from the wireless power transmitter. Additionally, the charging circumstance may include, for example, a current ratio, a voltage ratio, and/or a power ratio between the wireless power transmitter and the wireless power receiver. That is, the charging circumstance may include a ratio of the current, voltage, and/or power measured at the front end of the DC/DC converter, to current, voltage, and/or power, respectively, which are measured in the wireless power transmitter.

In an example, the first communication controller 1111 may determine whether the charging circumstance satisfies the predetermined condition, while maintaining a frequency band of wireless power transmission. That is, the first communication controller 1111 may control the power transmitter 1112 to continue to wirelessly transmit power to the wireless power receiver, while the first communication controller 1111 determines whether the charging circumstance satisfies the predetermined condition. For example, the first communication controller 1111 may determine whether the charging circumstance satisfies the predetermined condition, while controlling the power transmitter 1112 to maintain the frequency band in which power is wirelessly transmitted.

When the charging circumstance is determined to satisfy the predetermined condition, the first communication controller 1111 controls the power transmitter 1112 to transmit power to be used to charge the load device 1123. The power transmitter 1112 may include, for example, a source resonator, a PA, and a variable SMPS, as described in FIG. 1. The internal power information may be measured between the source resonator and the PA, between the PA and the variable SMPS, at a rear end of the variable SMPS, and/or at other locations known to one of ordinary skill in the art. For example, the current ratio, the voltage ratio, and/or the power ratio of the charging circumstance may be determined based on a ratio of the power detection information of the wireless power receiver to the respective internal power information.

The power source 1113 supplies power to the power transmitter 1112 and the first communication controller 1111. The supplied power is transmitted to the power receiver 1122 to charge the load device 1123.

The second communication controller 1121 transmits, to the wireless power transmitter, the power detection information to be used to determine the charging circumstance of the load device 1123. The power detection information may include, for example, current, voltage, and/or power measured at the front end of the DC/DC converter. In an example, the second communication controller 1121 may determine the charging circumstance based on the power detection information, and determine whether the charging circumstance satisfies the predetermined condition. In this example, when the charging circumstance is determined not to satisfy the predetermined condition, the second communication controller 1121 may transmit a charging stop signal to the wireless power transmitter. For example, the second communication controller 1121 may transfer, to the first communication controller 1111, a digital signal, for example, a digital signal “1” indicating that the charging circumstance satisfies the predetermined condition, and a digital signal “0” indicating that the charging circumstance does not satisfy the predetermined condition. The charging stop signal may be set to the digital signal “0”, for example.

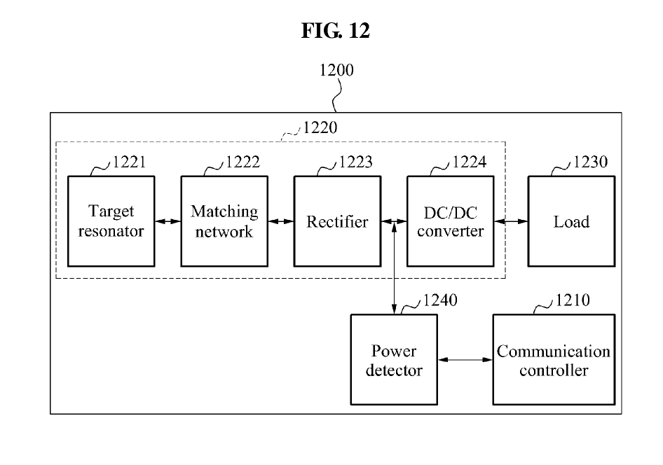

The power receiver 1122 receives the power to be used to charge the load device 1123. An example of a configuration of the power receiver 1122 will be further described with reference to FIG. 12.

The load device 1123 may include an application, for example, a TV, an electric vehicle, a digital camera, a smart device, and/or other devices known to one of ordinary skill in the art. The load device 1123 is charged by the power received by the power receiver 1122.

A power detector (not illustrated) may detect the power detection information to be used to determine the charging circumstance, while the power receiver 1122 wirelessly receives power. The power detector will be further described with reference to FIG. 12.

FIG. 12 is a diagram illustrating an example of a wireless power receiver 1200. Referring to FIG. 12, the wireless power receiver 1200 includes a communication controller 1210, a power receiver 1220, a load 1230, and a power detector 1240. The power receiver 1220 includes a target resonator 1221, a matching network 1222, a rectifier 1223, and a DC/DC converter 1224 that may be similar to the target resonator 131, the matching network 121, the rectifier 122, and the DC/DC converter 123, respectively, of FIG. 1. The communication controller 1210 and the load 1230 may be similar to the second communication controller 1121 and the load device 1123 of FIG. 11.

The power detector 1240 detects power detection information from a front end of the DC/DC converter 1224. For example, the power detector 1240 may detect voltage, current, and/or power between a rear end of the rectifier 1223 and the front end of the DC/DC converter 1224. The power may be determined by multiplication of the current and the voltage. Accordingly, a wireless power transmitter may determine a charging circumstance based on the power detection information received from the wireless power receiver 1200.

Voltage measured at a rear end of the DC/DC converter 1224 may be maintained to be constant, regardless of a load condition. In an example, the power detection information may be detected from the rear end of the DC/DC converter 1224 based on the voltage maintained to be constant, even when the target resonator 1221 receives unstable power or insufficient power. Accordingly, the detected power detection information may not be matched to actually received power. When charging is performed based on the power detection information, overvoltage may occur in the wireless power receiver 1200.

In the example of FIG. 12, the power detection information is detected between the rectifier 1223 and the DC/DC converter 1224. Accordingly, the wireless power transmitter and the wireless power receiver 1200 may detect the power detection information matched to the actually received power.

Additionally, the power detector 1240 may detect the power detection information, while a frequency band in which power is wirelessly received, is maintained, and while the wireless power is continuously received. Accordingly, the wireless power transmitter may consecutively determine the charging circumstance based on the received power detection information, and thus, the wireless power transmission system may maintain charging without interruption.

In a space-type wireless power transmission circumstance with a continuously changed characteristic, a charging circumstance may also be consecutively determined Additionally, since a virtual load system or a frequency change system used to observe a change in a coupling coefficient is not needed, complexity of a wireless power transmission system used to determine a charging circumstance may be reduced. For example, a wireless power transmission system may additionally include only a power detector to be used to determine a charging circumstance.

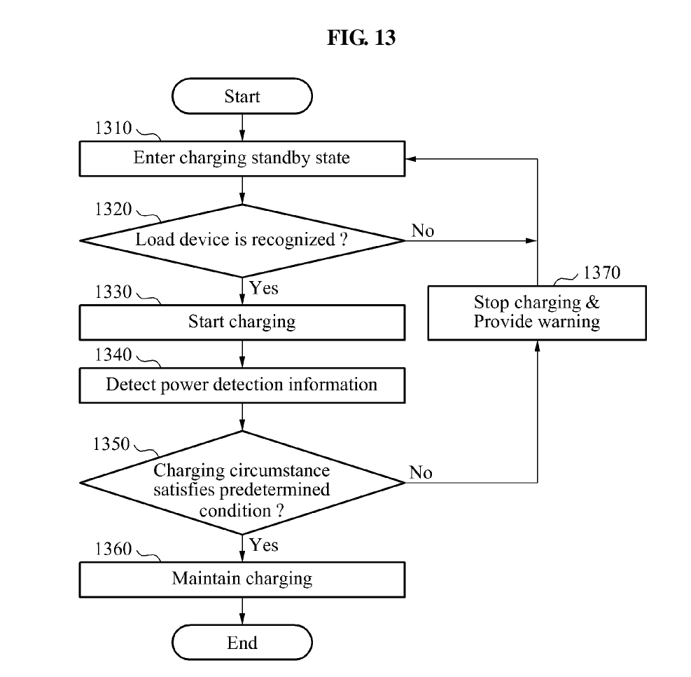

FIG. 13 is a flowchart illustrating an example of a wireless power transmission method. Referring to FIG. 13, in operation 1310, a wireless power transmission system (a wireless power transmitter and a wireless power receiver) enters a charging standby state. For example, the wireless power transmitter and the wireless power receiver may be operated by independent power sources, instead of exchanging power.

In operation 1320, the wireless power transmitter determines whether a load device is recognized. For example, the wireless power transmitter may recognize, using a first communication controller, a communicable load device that is located adjacent to the wireless power transmitter. In this example, the load device may be included in the wireless power receiver. When the load device is determined to be not recognized, the method returns to operation 1310, and the wireless power transmission system enters the charging standby state again. Otherwise, the method continues in operation 1330.

In operation 1330, the wireless power transmitter starts charging. That is, the wireless power transmitter wirelessly transmits power to the wireless power receiver to charge the load device. In an example in which the wireless power transmitter transmits electromagnetic energy through a source resonator, the wireless power receiver may receive the electromagnetic energy through a target resonator, as described above with reference to FIGS. 1 through 4B.

In operation 1340, the wireless power receiver detects power detection information. The wireless power receiver may detect, using a power detector, the power detection information from a front end of a DC/DC converter of a power receiver. The power detection information may be electrical information, and may include, for example, current, voltage, and/or power that is measured between the DC/DC converter and a rectifier of the power receiver. The wireless power receiver may detect the power detection information, while maintaining a frequency band in which power is wirelessly received. Since the frequency band remains unchanged, the wireless power receiver may detect the power detection information, while maintaining the wireless power transmission from the wireless power transmitter.

In operation 1350, the wireless power transmitter and/or the wireless power receiver determine whether a charging circumstance of the load device satisfies a predetermined condition. The charging circumstance is determined based on the power detection information. The predetermined condition may include, for example, a current condition, a voltage condition, and/or a power condition that are needed to normally operate the load device. For example, if the load device is normally operated in at least 5 V, the predetermined condition may be set to need the voltage of the front end of the DC/DC converter to be greater than or equal to 5 V.

In an example, the wireless power transmitter may determine the charging circumstance based on power detection information received from the wireless power receiver. The charging circumstance may include, for example, current, voltage and/or power measured at the front end of the DC/DC converter of the wireless power receiver, and/or a ratio of internal power information of the wireless power transmitter to the respective power detection information received from the wireless power receiver. The internal power information may include, for example, current, voltage, and/or power measured in the wireless power transmitter.

In another example, the wireless power receiver may determine the charging circumstance based on the power detection information. If the wireless power receiver determines that the charging circumstance does not satisfy the predetermined condition, the wireless power receiver may transmit a charging stop signal to the wireless power transmitter. In response to the charging stop signal, the wireless power transmitter may determine that the charging circumstance does not satisfy the predetermined condition.

When the charging circumstance is determined to satisfy the predetermined condition, the method continues in operation 1360. Otherwise, when the charging circumstance (e.g., the voltage, current, and/or the power of the power detection information) is determined to not satisfy the predetermined condition, the method continues in operation 1370.

In operation 1360, the wireless power transmitter maintains the charging. That is, when an operation, such as changing a frequency, is not performed during operations 1340 and 1350, the charging may continue to be performed without interruption.

In operation 1370, the wireless power transmitter stops the charging, and provides a user (of the wireless power transmitter and/or the wireless power receiver) with a warning that indicates the stopping of the charging. When the charging is stopped, the wireless power transmitter does not transmit power to the wireless power receiver. The warning may include, for example, a request to remove foreign substances between the wireless power transmitter and the wireless power receiver, a charging stop message, a request to move the wireless power transmitter, a request to move the wireless power receiver, and/or other messages known to one of ordinary skill in the art.

As described above, when a charging circumstance of a load device is determined to fail to satisfy a predetermined condition needed by a wireless power receiver, the examples of a wireless power transmission system may stop charging of the load device, and may provide current state information to a user (of a wireless power transmitter and/or the wireless power receiver. Additionally, it is possible to determine whether the charging is to be continuously performed based on a change in the charging circumstance, while maintaining the charging, even when the charging circumstance continues to be changed in a space-type wireless power transmission circumstance after the charging is started. Since the charging is not interrupted, the entire wireless power transmission system may be stably operated.

Moreover, the examples of a wireless power transmission system described may determine whether a charging circumstance is appropriate based on power detection information, regardless of a system efficiency information calculation scheme, for example, a scheme using a change in an impedance, a change in a coupling coefficient, and/or a change in a voltage gain curve. Furthermore, it is possible to easily determine whether the charging circumstance is appropriate based on power detection information, even when a voltage gain is greatly changed based on a change in load power, or even when a resonant frequency remains almost unchanged, due to a low coupling coefficient between a wireless power transmitter and a wireless power receiver. In addition, it is possible to determine whether the charging circumstance is appropriate, regardless of a location in which voltage and current of a wireless power transmitter are measured. Additionally, it is possible to implement the wireless power transmitter with a memory with a smaller capacity, since the wireless power transmitter receives data in a simple form from the wireless power receiver.

The various units, modules, elements, and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

As a non-exhaustive illustration only, a terminal or device described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blue-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless power receiver comprising:
a power receiver configured to wirelessly receive power, and comprising a direct current (DC)-to-DC (DC/DC) converter; and
a power detector configured to detect power detection information from a front end of the DC/DC converter.

2. The wireless power receiver of claim 1, wherein the power is used to charge a load.

3. The wireless power receiver of claim 1, further comprising:
a communication controller configured to transmit the power detection information to a wireless power transmitter.

4. The wireless power receiver of claim 1, wherein the power detector is configured to detect the power detection information, while maintaining a frequency band in which the power is wirelessly received.

5. The wireless power receiver of claim 1, wherein the power detector is configured to detect the power detection information, while the power receiver wirelessly receives the power.

6. The wireless power receiver of claim 1, wherein:
the power receiver further comprises a rectifier; and
the power detector is configured to detect the power detection information between the DC/DC converter and the rectifier.

7. The wireless power receiver of claim 1, further comprising:
a communication controller configured to
determine a charging circumstance of a load based on the power detection information,
determine whether the charging circumstance satisfies a predetermined condition, and
transmit a charging stop signal to a wireless power transmitter in response to the charging circumstance being determined to not satisfy the predetermined condition.

8. The wireless power receiver of claim 1, wherein the power detection information comprises current, or voltage, or power, or any combination thereof at the front end of the DC/DC converter.

9. A wireless power transmitter comprising:
a communication controller configured to receive, from a wireless power receiver, power detection information detected from a front end of a direct current (DC)-to-DC (DC/DC) converter of the wireless power receiver; and
a power transmitter configured to wirelessly transmit power based on the power detection information.

10. The wireless power receiver of claim 9, wherein the power is used to charge a load.

11. The wireless power transmitter of claim 9, wherein the communication controller is further configured to:
determine a charging circumstance of a load based on the power detection information; and
determine whether the charging circumstance satisfies a predetermined condition.

12. The wireless power transmitter of claim 11, wherein the power transmitter is configured to wirelessly transmit the power to the wireless power receiver in response to the charging circumstance being determined to satisfy the predetermined condition.

13. The wireless power transmitter of claim 11, wherein the communication controller is configured to determine whether the charging circumstance satisfies the predetermined condition, while maintaining a frequency band in which the power is wirelessly transmitted.

14. The wireless power transmitter of claim 11, wherein the power transmitter is configured to continue to wirelessly transmit the power to the wireless power receiver, while the communication controller determines whether the charging circumstance satisfies the predetermined condition.

15. The wireless power transmitter of claim 11, wherein the communication controller is configured to:
determine whether the load is recognized; and
determine whether the charging circumstance satisfies the predetermined condition in response to the load being recognized.

16. The wireless power transmitter of claim 9, wherein the power detection information comprises current, or voltage, or power, or any combination thereof at the front end of the DC/DC converter.

17. A wireless power reception method comprising:
wirelessly receiving power, using a power receiver comprising a direct current (DC)-to-DC (DC/DC) converter; and
detecting power detection information from a front end of the DC/DC converter.

18. The wireless power reception method of claim 17, further comprising:
transmitting the power detection information to a wireless power transmitter.

19. The wireless power reception method of claim 17, further comprising:
determining a charging circumstance of a load based on the power detection information;
determining whether the charging circumstance satisfies a predetermined condition; and
transmitting a charging stop signal to a wireless power transmitter in response to the charging circumstance being determined to not satisfy the predetermined condition.

20. A wireless power transmission method comprising:
receiving, from a wireless power receiver, power detection information detected from a front end of a direct current (DC)-to-DC (DC/DC) converter of the wireless power receiver; and
wirelessly transmitting power based on the power detection information.

21. The wireless power transmission method of claim 20, wherein the wirelessly transmitting comprises:
determining a charging circumstance of a load based on the power detection information;
determining whether the charging circumstance satisfies a predetermined condition; and
wirelessly transmitting the power to the wireless power receiver in response to the charging circumstance being determined to satisfy the predetermined condition.

22. The wireless power transmission method of claim 21, further comprising:
stopping the wirelessly transmitting, and providing a user with a warning that indicates the stopping, in response to the charging circumstance being determined to not satisfy the predetermined condition.

23. A wireless power receiver comprising:
a resonator configured to wirelessly receive power from a wireless power transmitter;
a direct current (DC)-to-DC (DC/DC) converter connected to the resonator; and
a power detector configured to detect current, or voltage, or power, or any combination thereof at a front end of the DC/DC converter.

24. The wireless power receiver of claim 23, further comprising:
a communication controller configured to transmit, to the wireless power transmitter, the detected current, or voltage, or power, or any combination thereof.

25. The wireless power receiver of claim 23, further comprising:
a rectifier configured to rectify the power to a DC voltage,
wherein
the DC/DC converter is configured to adjust the DC voltage, and
the power detector is configured to detect the current, or voltage, or power, or any combination thereof between the rectifier and the DC/DC converter.

26. The wireless power receiver of claim 23, wherein the wireless power receiver is an electric vehicle, or a smart device, or a laptop, or a camera, or any combination thereof.
